(19) United States
(12) Patent Application Publication
(10) Pub. No.: US 2008/0276050 A1
(43) Pub. Date: Nov. 6, 2008

(54) ERASE HANDLING METHOD FOR NON-VOLATILE MEMORY AND ELECTRONIC APPARATUS THEREOF

(76) Inventors: Yu-Cheng Hsieh, Hsin-Chu City (TW); Bing-Yu Wang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/743,645

(22) Filed: May 2, 2007

(51) Int. Cl. G06F 13/00

(52) U.S. Cl. 711/154

(57) ABSTRACT

For an electronic apparatus with a sleep mode and an operation mode, an erasing command is issued to a memory controller that controls a non-volatile memory device before the electronic apparatus is entering the sleeping mode. Preferably, an estimated sleeping time is compared with a predetermined threshold for determining whether to activate erase operations to release space from the non-volatile memory device. Further, when the electronic apparatus returns from the sleep mode to the operation mode, the erase operations are checked whether they are complete. If the erase operations are not completed, another erase command is issued to the memory controller next time when the electronic apparatus is going to the sleep mode again.

### BACKGROUND

The invention relates to a method and electronic apparatus for managing a non-volatile memory, and more particularly, to a method and electronic apparatus for managing erase operations of a non-volatile memory.

A flash memory is a memory device that allows data writing, reading, and erasing operations for multiple times. Data stored in a flash memory are retained even power is turned off. With these advantages, flash memory devices are widely applied in personal computers and electronic equipments such as cell phones. Flash memory devices can be designed with one bank or multi-banks. FIG. 1 is a diagram of a conventional multi-bank flash memory 100. As shown in FIG. 1, the multi-bank flash memory 100 divides the flash array into multiple banks A-D. Under such design, data in some banks can be read while the data in other banks can be erased or programmed. Sometimes, program codes and data are stored in different banks so that program codes can be executed and the data can be programmed (written) for the same time. For example, program codes are stored in the partitions A-C, which correspond to a 7 MB storage space and data are stored in the partition D, which corresponds to a 1 MB storage space. In this example, if the data stored in the partition D are programmed or erased, the program codes are still able to be executed (read) from partitions A-C. Unfortunately, in the above-mentioned multi-bank flash memory architecture, the flash memory 100 is divided into multiple partitions. These partitions are regarded as a limitation of access. For example, if 6 MB program codes and 2 MB data need to be stored inside the multi-bank flash memory 100, obviously, the above multi-bank flash memory 100 can no longer be utilized due to the limitations of storage space of each partition. Furthermore, in the multi-bank flash memory 100, each bank associates with an internal state machine (ISM) for controlling operations of the memory 100, which results in a high cost.

Please refer to FIG. 2, which is a diagram of a conventional single-bank flash memory 200. As shown in FIG. 2, the single-bank flash memory 200 is not partitioned. Therefore, when the single-bank flash memory 200 is accessed, data or program codes are not limited to be stored in a certain space. That is, they can be stored anywhere inside the memory 200 as long as there are free storage spaces. Moreover, because the flash memory 200 only has one bank, only one ISM is needed. This results in a low cost.

The single-bank flash memory 200 has its disadvantages, too. Reading, programming, and erasing operations cannot be performed at the same time. This property directly increases the handling overhead.

Please refer to FIG. 3, which illustrates operations of the multi-bank flash memory 100 shown in FIG. 1 and the single-bank flash memory 200 shown in FIG. 2. As shown in FIG. 3, for multi-bank flash memory 100, erasing and reading operations can be performed simultaneously in different banks. In a single-bank flash memory 200, the reading and erasing operations have to be performed alternately. In general, the reading operation often requires less time than the erasing or programming operations. Therefore, when a certain reading operation needs to be performed, the current erasing operation is suspended, and after the reading operation is completely performed, the aforementioned erasing operation can be resumed.

There is usually a limitation on suspend/resume time. If the suspend time or resume time exceeds the limit, the block of flash memory being suspended may fail. There is also a limitation on the erase interval, specified as an erase pulse period T. Generally speaking, the erase pulse period T needs to be longer than 10 ms. Unfortunately, in some embedded systems, there is often a regular interrupt. For example, in a GSM/GPRS communication system, the regular interrupt has a 4.615 ms interval. The 4.615 ms interval is shorter than the 10 ms limitation. This makes the erase pulse period T too short, and also prevents the single-bank flash memory from being utilized inside the GSM/GPRS communication system.

### SUMMARY

A first preferred embodiment according to the invention is an electronic apparatus having a sleep mode and an operating mode. The electronic apparatus includes a non-volatile memory, e.g. a NOR flash, a memory controller for controlling the non-volatile memory and a processor for issuing an erase command to the memory controller before the processor is going to enter the sleep mode.

When the memory controller receives the erase command, it performs an associate erase operation. When the processor returns from the sleep mode back to the operating mode, the processor checks whether the erase operation is completed. If the erase operation is not completed, the processor issues another erase command to the memory controller next time when the processor is going to enter the sleep mode again. In addition, an erase queue may be maintained for recording which blocks on the non-volatile memory device should be erased for releasing programmable memory space for further use. If there is no sufficient memory space on the non-volatile memory device, a shadow memory in anther memory device may be maintained and contents of the shadow memory are later written back to the non-volatile memory device. With such, even there are regular interrupts occurred in the electronic apparatus, erase operation can still be performed effectively.

Another preferred embodiment is a method for handling erase operation of a non-volatile memory device in an electronic apparatus that has a sleep mode and an operating mode. The non-volatile memory device is capable of being read and written in addition to the erase operation. The method includes a step of issuing an erase command to a memory controller to perform associated erase operation on the non-volatile memory device before the electronic apparatus enters the sleep mode. The method also includes a step of making the electronic apparatus entering the sleep mode. The method may be implemented into corresponding program codes and/or digital logic circuits executed by processors and/or controllers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional multi-bank flash memory.

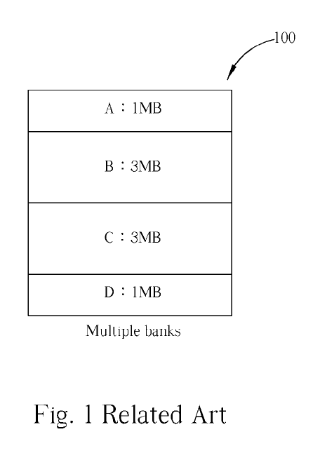

FIG. 2 is a diagram of a conventional single-bank flash memory.

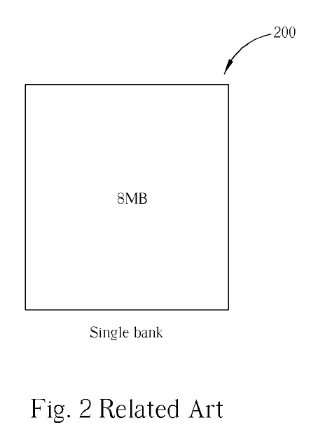

FIG. 3 illustrates operations of the multi-bank flash memory shown in FIG. 1 and the single-bank flash memory shown in FIG. 2.

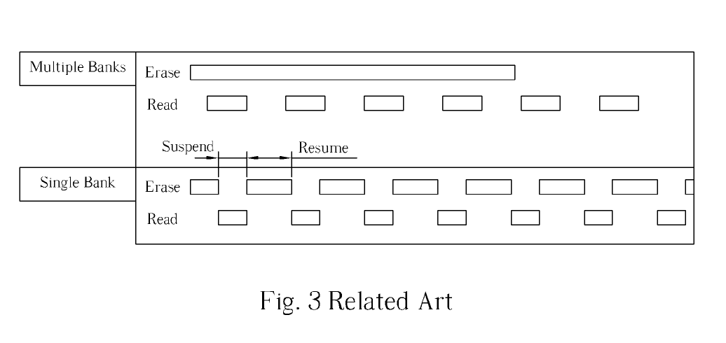

FIG. 4 is a simplified diagram of a cell phone according to the present invention.

FIG. 5 is a flow chart of managing the single-bank flash memory according to the present invention.

### DETAILED DESCRIPTION

A first preferred embodiment is an electronic apparatus that has a sleep mode and an operating mode. Compared with staying in the operating mode, the electronic apparatus in the sleeping mode shuts down or temporarily close certain circuits for power saving. The electronic apparatus has a non-volatile memory device, a memory controller and a processor. The memory controller, which may be implemented with an internal simple circuit of a finite state machine or a complicated controller circuit running related codes, is used for controlling the non-volatile memory device. The processor is configured and capable of issuing an erase command to the memory controller when the processor is going to enter the sleep mode. As instructed by the erase command, the memory controller performs associated erase operations on the non-volatile memory device.

Usually, the processor may return from the sleep mode to the operation mode when receiving certain interrupts. When this happens, the erase operation, e.g. to erase 100 blocks, may not be completed yet, e.g. only 40 blocks erased. When this happens, the processor may record the status and issue another erase command to the memory controller next time when the processor is going to enter the sleep mode again. There may be also an erase queue for storing erase tasks to be performed. An entry of the erase queue may indicate certain blocks of the non-volatile memory to be erased. When there is no sufficient space in the non-volatile memory device due to not releasing erasable blocks yet, a shadow memory space may be maintained. The contents of the shadow memory may be later updated to the non-volatile memory when there is sufficient space released via certain erase operations.

Moreover, an erase operation may take several steps, initialization, generating a current with a charge pump and applying the current to assigned memory units. These steps may take certain long time, e.g. 10 ms and may be interrupted for handling other events. If the processor may estimate how long the processor will stay in the sleep mode before enters the sleep mode, the estimated sleeping time may be compared with a threshold, e.g. the 10 ms as mentioned above, and accordingly determine whether to issue the erase command to the memory controller. With such, it may not waste time on unnecessary repetition of erase and resume.

The above mentioned design of the electronic apparatus is useful for designing handheld devices and should be more useful to be applied on mobile phones that receive regular interrupts. For example, a mobile phone under GSM receives an interrupt each 4.615 ms under an operating mode. In such case, if program codes and user data, e.g. a photo image, are stored at the same bank of a NOR flash device that needs erase operations to release memory space, it is difficult to complete an effective erase operation under the operating mode because an erase operation is too often interrupted before it can be completed. With such design of the invention, the erase operation may be performed in the sleeping mode, under which the mobile phone of GSM may not need to handle the regular interrupts. Therefore, even using a single bank non-volatile memory device for storing both program codes and user data, there is still enough memory space released from effective erase operations.

There are various ways for implementing the above-mentioned embodiment. For example, a driver for the non-volatile may be provided in the format of program codes that issues erase commands to instruct a corresponding memory controller, which may be implemented as an internal finite state machine, to perform erase operations on the non-volatile memory. The following description explains the embodiment in several examples in more details.

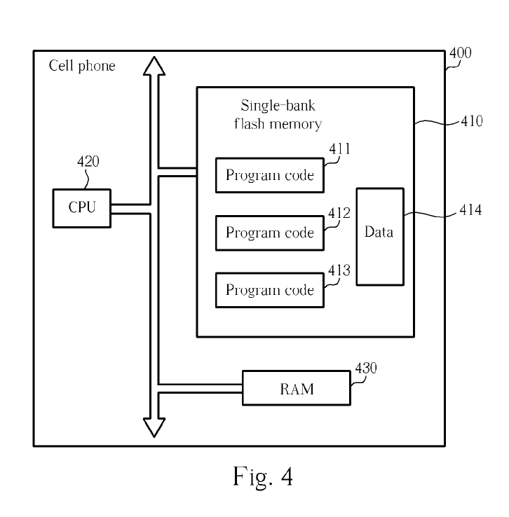

Please refer to FIG. 4, which is a simplified diagram of a cell phone 400 as an example of the invention. As shown in FIG. 4, the cell phone 400 includes a CPU 420, a single-bank flash memory 410, a random access memory (RAM) 430, and a bus 440. The single-bank flash memory 410 stores data 415 and program codes 411, 412, and 413. The flash memory 410 has sufficient capacity to store more data and program codes. The CPU 420 can execute these program codes and fetch the data from the flash memory 410 through the bus 440 to perform some predetermined functions, such as allowing the user to pickup the phone or select some operations, and communicate with base stations. In general, the RAM 430 has better accessing efficiency than the flash memory 410. Therefore, in some applications, the program codes stored in the flash memory 410 are first loaded into the RAM 430 through the bus 420, and then executed by the CPU 420 such that better execution efficiency can be achieved. Please note that the RAM 430 is an optional device in this embodiment. In other words, the CPU 420 can directly execute the program codes inside the flash memory 410, and this also obeys the spirit of the present invention.

Furthermore, the program codes 411˜413 shown in FIG. 4 are used for managing the single-bank flash memory 410. Other program codes for other functions, (such as for supporting the above-mentioned communications between the cell phone 400 and base station), are already known by those skilled in the art, so they are omitted here and from FIG. 4. In addition, the operation of these devices and the program codes are illustrated as follows.

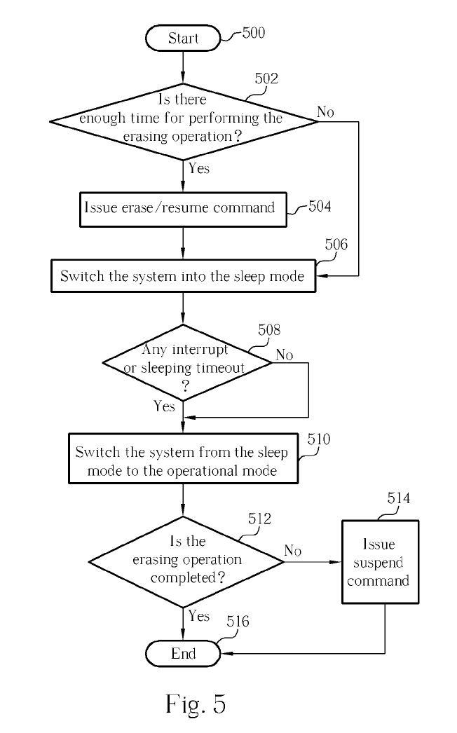

Please refer to FIG. 5, which is a flow chart of managing the single-bank flash memory 410 inside the cell phone 400 shown in FIG. 4 according to the present invention. It comprises the following steps:

### Step 500: Start;

Step 502: Is there enough time for performing the erasing operation? If there is enough time, then go to step 504; otherwise, go to step 506:
Step 504: Issue erase/resume command;
Step 506: Switch the system into the sleep mode;
Step 508: Any interrupt or sleeping timeout? If yes, then go to step 510, otherwise wait until there is an interrupt or the sleeping timeout triggers.
Step 510: Switch the system from the sleep mode to the operational mode;
Step 512: Is the erasing operation completed? If yes, go to step 516; otherwise, go to step 514;
Step 514: Issue a suspend command;

### Step 516: End.

When the cell phone 400 is idle for a time, the cell phone 400 will be switched from the operational mode into the sleep mode (step 500). First, before switching the cell phone 400 into the sleep mode, the CPU 420 will execute the program code 411 to detect the sleep time duration of the sleep mode (step 502). As mentioned previously, the erase pulse period T is limited as 10 ms. Obviously, if the sleep time duration is not longer than 10 ms, the sleep time duration is not enough to perform any erasing operation. Therefore, if the sleep time duration is longer than 10 ms, the CPU 420 executes the program code 412 to issue an erase/resume command. Please note that the erase command is generated because a block of the flash memory 410 needs to be erased. The resume command is generated because an erasing operation is not performed completely in the previous sleep time duration. The CPU 420 then executes the program code 413 to switch the cell phone 400 into the sleep mode (Step 506). Therefore, in the following sleep mode, at least a block of the single-mode flash memory 410 is erased.

On the other hand, if the sleep time duration is not long enough the CPU 420 will directly execute the program code 413 to switch the cell phone 400 into the sleep mode (Step 506). In this case the single-mode flash memory 410 will not be erased in the following sleep mode, as it is shorter than 10 ms.

Then, as is well known, the cell phone 400 exits sleep mode in two situations. The first situation is that the cell phone 400 receives an interrupt (for example, the user may push a button of the cell phone 400 such that the cell phone 400 needs to respond); the second situation is that the sleep time duration is over.

If one of the above-mentioned situations is satisfied, the CPU 410 will execute the program code 413 to switch the cell phone 400 from the sleep mode back to the operational mode (Step 510). As mentioned previously, when the cell phone 400 operates in the operational mode, the cell phone 400 receives regular interrupts such that the flash memory 410 cannot be erased. The left erasing operation therefore needs to be suspended when the cell phone 400 is back in operational mode.

In this embodiment, the CPU 410 executes the program code 422 to issue a suspend command to suspend the erasing operation (Step 514). The left erasing operation will be completely performed following one or more sleep time durations (step 516). Of course, if the entire erasing operation is completely performed in the previous sleep time duration, the cell phone 400 works normally until another erasing operation is needed.

From the above disclosure, it is clear that the present invention is able to erase the single-mode flash memory, which is used inside a cell phone. In other words, the present invention allows the single-mode to be utilized without disturbs caused by interrupts.

In general, because the erasing operation of the flash memory is complicated and needs more processing time, the data stored inside the flash memory is not “really” erased. Instead, the flash memory often utilizes flags to label the location of the memory space where the data originally stored in the location has been erased. In this way, the data do not need to be erased immediately, and can instead be erased whenever the flash memory is capable of being erased.

Obviously, the data that have to be erased still occupy a lot of memory space of the flash memory if they have not been erased. In some cases, however, there may be other data to be written into the single-mode flash memory, and the data to be written may be larger than the remaining memory space of the single-mode flash memory. This means data in the single-mode flash memory needs to be erased first such that there is enough memory space to store new data. Therefore, in an embodiment, the data to be written can be first stored in a shadow space for buffering. For example, the data can be first stored inside the RAM 430 and then be written into the single-mode flash memory 410 if enough blocks of the flash memory 420 have been erased.

Furthermore, the present invention does not limit the way of executing the program codes 421˜423. In other words, the CPU 410 can directly execute the program codes 421˜423 inside the flash memory 420, or the CPU 410 can first load the program codes 421˜423 from the flash memory 420 to the RAM 430, and then execute the program codes 421˜423 inside the RAM 430. These changes all obey the spirit of the present invention.

Please note, in the above disclosure, the erasing operation is only utilized as a preferred embodiment, and not a limitation of the present invention. That is, the present invention can also properly program the single-mode flash memory in the sleep mode such that disturbs caused by interrupts can be removed. This also obeys the spirit of the present invention.

In addition, please note that the cell phone is only utilized as a preferred embodiment, and not a limitation of the present invention. In other words, the present invention method and single-mode flash memory can be utilized inside many kinds of wireless communication system. For example, the present invention can be utilized inside GSM or GPRS communication systems.

Furthermore, the flash memory is also utilized as a preferred embodiment, and not a limitation. That is, the present invention method can be utilized to manage (erase or program) other kinds of non-volatile memories. This also obeys the spirit of the present invention.

In contrast to the prior art, the present invention can properly manage the single-bank flash memory so that the single-bank flash memory can work without influences of the interrupts of the communication system. In other words, the present invention can utilize the single-bank flash memory as the storage device of a communication system such as a cell phone. Therefore, the cost of the entire cell phone is lower.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic apparatus having a sleep mode and an operation mode, comprising:
a non-volatile memory device;
a memory controller for controlling read operation, write operation and erase operation on the non-volatile memory device; and
a processor for issuing an erase command to the memory controller for performing the erase operation of the non-volatile memory before the processor enters the sleep mode.

2. The electronic apparatus of claim 1, wherein when the processor returns from the sleep mode into the operation mode, the processor checks whether the erase operation associated to the erase command issued before entering the sleep mode has been completed; and if the erase operation is not completed, the processor issues another erase command to resume the erase operation when the processor is going to enter the sleep mode again.

3. The electronic apparatus of claim 1, wherein the processor determines whether to issue the erase command before entering the sleep mode based on whether an estimated sleeping time is longer than a predetermined threshold.

4. The electronic apparatus of claim 1, wherein the time for performing the erase operation on the non-volatile memory device is longer than the time of a regular interrupt received and handled by the processor.

5. The electronic apparatus of claim 4, wherein the processor handles wireless communication and the regular interrupt is used for the wireless communication.

6. The electronic apparatus of claim 5, wherein the wireless communication comprises GSM.

7. The electronic apparatus of claim 1, wherein the non-volatile memory device is a NOR flash device and stores program codes to be executed by the processor, and the erase command is included in a driver of the program codes.

8. The electronic apparatus of claim 7, wherein the driver maintains an erase queue for recording which blocks of the non-volatile memory device are necessary to be erased.

9. The electronic apparatus of claim 8, wherein the driver maintains a shadow memory space in another memory device to be used before necessary space in the non-volatile memory device is released by the erase operation.

10. The electronic apparatus of claim 1, wherein the non-volatile memory device is a single bank memory device.

11. A method for handling erase operation of a non-volatile memory device in an electronic apparatus that has a sleep mode and an operation mode, the non-volatile memory device is capable of being read and write in addition to the erase operation, the method comprising:
issuing an erase command to a memory controller to perform associated erase operation on the non-volatile memory device before making the electronic apparatus entering the sleep mode; and
making the electronic apparatus entering the sleep mode.

12. The method of claim 11, further comprising:
estimating an estimated sleeping time of the electronic apparatus to be stayed in the sleep mode; and
determining whether to issue the erase command based on whether the estimated sleeping time is longer than a predetermined threshold.

13. The method of claim 12, further comprising:
when the electronic apparatus returns from the sleep mode to the operation mode, checking whether the erase operation associated to the erase command issued before the electronic apparatus enters the sleep mode is completed; and
if the erase command is not completed, issue another erase command next time when the electronic apparatus is going to the sleep mode again.

14. The method of claim 11, wherein the time for performing the erase operation on the non-volatile memory is longer than the time of a regular interrupt received and handled by the electronic apparatus.

15. The method of claim 14, wherein the electronic apparatus is a wireless communication device.

16. The method of claim 15, wherein the wireless communication device is compatible with the GSM standard.

17. The method of claim 11, wherein the non-volatile memory device is a NOR flash device.

18. The method of claim 11, further comprising:
maintaining a shadow memory space in another memory device to be used before necessary space in the non-volatile memory device is released by the erase operation.

19. The method of claim 11, wherein the non-volatile memory device is a single bank memory device.

20. The method of claim 11, wherein the memory controller comprises a state machine circuit.
